(19) United States
(12) Patent Application Publication
(10) Pub. No.: US 2007/0234378 A1
(43) Pub. Date: Oct. 4, 2007

(54) Data storage medium with visual sensor element to sense environmental degradation

(75) Inventor: Jathan D. Edwards, Afton, MN (US)

Correspondence Address: Attention: Eric D. Levinson;Imation Corp., Legal Affairs, P.O. Box 64898, St. Paul, MN, 55164-0898, US

(73) Assignee: Imation Corp.

(21) Appl. No.: 11/390,565

(22) Filed: Mar. 28, 2006

(51) Int. Cl. G11B 7/24; G11B 23/03

(52) U.S. Cl. 720/718

(57) ABSTRACT

This disclosure describes a data storage medium, such as an optical disk, that includes a visually recognizable sensing element that changes in appearance in response to exposure to an environmental condition. The sensing element may sense any of a wide variety of environmental conditions, such as exposure to ultraviolet (UV) radiation, ozone, moisture, other non-UV spectrums of light, corrosive gasses, or the like. The invention can promote data integrity by alerting a user of possible media degradation.

### TECHNICAL FIELD

The invention relates to data storage media and, more particularly, optical data storage disks.

### BACKGROUND

Optical data storage disks have gained widespread acceptance for the storage, distribution and retrieval of large volumes of information. Optical data storage disks include, for example, audio CD (compact disc), CD-R (CD-recordable), CD-RW (CD-rewritable) CD-ROM (CD-read only memory), DVD (digital versatile disk or digital video disk), DVD-RAM (DVD-random access memory), and various other types of writable or rewriteable media, such as magneto-optical (MO) disks, phase change optical disks, and others.

Many optical blue disk media formats are also emerging, such as Blu-Ray and HD-DVD. The blue disk media formats may be compatible with a blue-laser drive head that operates at or near a wavelength of approximately 405 nm. As used herein, the term blue disk media (or blue disks) refers to optical disk media having a data storage capacity of greater than or equal to 15 gigabytes (GB) per data storage layer, or recording stack, of the disk. The blue disk media formats may include optically transmissive cover layers bonded over the optical disk.

One problem with optical disks is environmental degradation. Over time, environmental exposure can degrade the quality of optical disks, and in extreme cases may render the disks useless for data storage or retrieval. As one example, ultraviolet (UV) light exposure to the optical recording dyes used in some optical disks can degrade the recording dyes. Reflective layers or other materials used in optical disk constructions may also degrade upon exposure to UV light or other environmental contaminants.

### SUMMARY

In general, the invention is directed to a data storage medium, such as an optical disk, that includes a visually recognizable sensing element that changes in appearance in response to exposure to an environmental condition. A user of the medium can be alerted to possible media degradation, and can store data in another location, if desired. The sensing element may sense any of a wide variety of environmental conditions, such as exposure to ultraviolet (UV) radiation, ozone, moisture, non-UV spectrums of light, corrosive gasses, or the like.

In one embodiment, a data storage medium comprises a visually recognizable sensing element that changes in appearance in response to exposure to an environmental condition. The data storage medium may comprise an optical disk that includes a substrate defining optically detectable features, and one or more layers formed on the substrate. The one or more layers, for example, may comprise a recording dye, which may be sensitive to UV radiation. In this case, the environmental condition may comprise UV radiation, and the sensing element may change in appearance in response to exposure to the UV radiation. The sensing element may be formed in any of a variety of locations on the optical disk, such as on a printed surface of the disk, or on an inner diameter portion of the disk.

The invention may provide one or more advantages. For example, by including a sensing element on an optical disk, a user of the disk can be alerted to possible media degradation. If the sensing element identifies possible media degradation, the user may store the optical disk or data from the disk in another location in order to better preserve such data. In this manner, the invention promotes the integrity of stored data on such media.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a perspective view of an optical disk that includes a sensing element in accordance with an embodiment of the invention.

FIG. 2 is another perspective view of an optical disk that includes a sensing element in accordance with an embodiment of the invention.

FIGS. 3A-3D are graphs illustrating different rates of decay for different colorants exposed to ultraviolet (UV) radiation.

FIG. 4 is a conceptual view of a sensing element that changes in appearance over time upon exposure to an UV radiation.

FIG. 5 is another conceptual view of a sensing element that changes in appearance over time upon exposure to an UV radiation.

### DETAILED DESCRIPTION

The invention provides a data storage medium that includes a visually recognizable sensing element. The sensing element changes in appearance in response to exposure to an environmental condition. Details of the invention are set forth in the context of optical disks, although the described sensing element could also be applied to a wide variety of other types of storage media such as holographic disks, portable flash memory device, or magnetic tape cartridges. Furthermore, details of the invention are described with respect to a sensing element that senses exposure to ultraviolet radiation, although the invention also contemplates sensing elements that can sense other environmental conditions that can degrade data storage media.

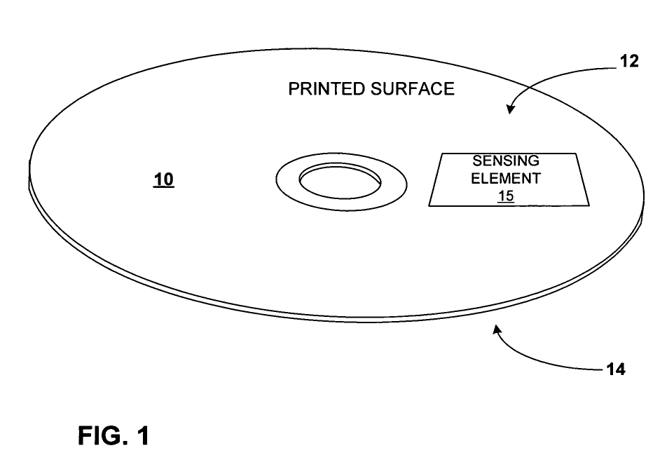

FIG. 1 is a perspective view of an optical disk 10 that includes a sensing element 15 in accordance with an embodiment of the invention. Optical disk 10 may comprise an audio CD (compact disc), a CD-R (CD-recordable), a CD-RW (CD-rewritable) a CD-ROM (CD-read only memory), a DVD (digital versatile disk or digital video disk), a DVD-RAM (DVD-random access memory), or another type of writable or rewriteable media, such as a magneto-optical (MO) disk, a phase change optical disk, or the like. Also, optical disk 10 may comprise a disk that complies with one of the emerging blue disk media formats, such as Blu-Ray and/or HD-DVD.

Optical disk 10 generally defines a first major surface 12 and a second major surface 14. First major surface 12 may be a printed surface that includes screen printed artwork, although the invention is not limited in this respect. Optical disk 10 my include one or more substrates that define optically detectable features. Optical disk 10 may also include one or more layers formed on the substrate. These layers formed on the substrate can be susceptible to environmental degradation.

As one example of optical disk 10, a read-only compact disk (CD) generally includes a thermoplastic substrate that is injection-molded to replicate optical features (such as a collection of lands and grooves). The optical features could also be “2P” replicated via a so-called rolling bead process. In any case, a reflective layer is formed on the optical features, followed by an optional protective layer of lacquer. As another example, optical disk 10 may comprise a recordable CD (CD-R) or other dye-based disk that includes a replicated substrate (e.g., created via injection molding or 2P replication), and a layer of recording dye formed over replicated features in the substrate. In this case, a reflective layer may be formed on the recording dye, followed by an optional protective layer. In still other examples, optical disk 10 may comprise a DVD (digital versatile disk or digital video disk) or recordable DVD (DVD-R). In this case, the DVD or DVD-R may be similar to a CD or CD-R construction, but typically includes two thin substrates that are bonded together. A DVD also defines a track pitch that is smaller than a CD.

As another example, optical disk 10 may comprise a so-called “Blu-disk,” such as a disk that complies with the Blue-ray or HD-DVD standards. For Blue-ray, optical disk 10 would include a replicated substrate, one or more recording layers and reflective layers, and a cover layer. In general, the invention could be used with any optical disk format and is not limited to any particular format or disk construction. Accordingly optical disk 10 could comply with any of the constructions mentioned above, or others.

In accordance with the invention, optical disk 10 includes a sensing element 15 formed on the surface of optical disk 10. Sensing element 15 is sensitive to one or more environmental conditions that may degrade optical disk 10. Sensing element 15 is a visual sensor in that sensing element 15 changes in appearance in response to exposure to an environmental condition. For example, sensing element 15 may change in appearance in response to exposure of ultraviolet UV radiation, ozone, moisture, other non-UV spectrums of light, corrosive gasses, or the like.

In the example of FIG. 1, sensing element 15 is formed on a printed surface of the medium. In this case, the first side 12 may be screen printed with artwork making first side 12 generally opaque. Sensing element 15 can alert the user of optical disk 10 of excessive exposure of side 12 to one or more environmental conditions. For example, if sensing element 15 is sensitive to UV radiation and optical disk 10 was left in the window of an automobile for an extended time, sensing element 15 may change in appearance to alert the user of possible degradation of disk 10. If side 12 is a printed surface, however, as shown in FIG. 1, exposure of side 12 to environmental contamination may not be adverse to optical recording layers such as dyes or reflectors, particularly if the printed surface blocks UV radiation.

Side 14 may be a transparent side. A read or write laser may access the recording layers of disk 10 via side 14. For this reason, it may be more advantageous to monitor possible environmental impact to the transparent side 14.

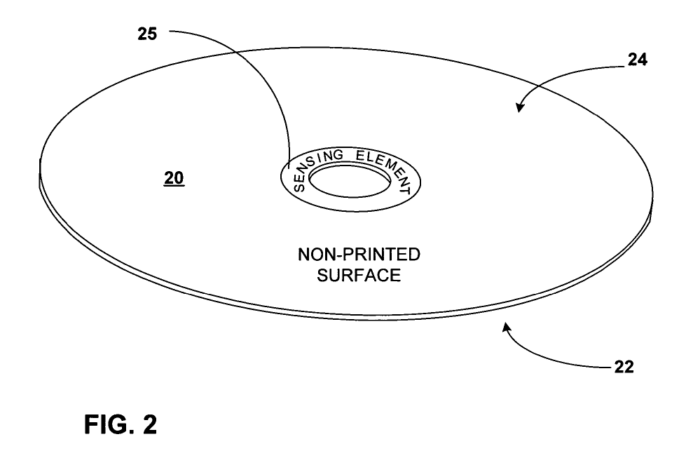

FIG. 2 is another perspective view of an optical disk 20 that includes a sensing element 25 in accordance with an embodiment of the invention. Disk 20 may be similar to disk 10 in all aspects, but defines sensor element 25 on an inner diameter portion of an otherwise transparent side of disk 20. In the illustration of FIG. 2, the transparent (non-printed surface) is shown face up as side 24. In this illustration, back side 22 may include the printed surface.

As shown in FIG. 2, sensing element 25 is formed on an inner diameter portion of the disk substrate. The inner diameter portion associated with sensing element 25 may include a small circumference around a centerhole that accommodates a spindle of an optical disk drive. The replicated features, dyes, and reflectors may be accessible, via optical lasers, through side 24, but such features and recording layers may not extend into the inner diameter portion of optical disk associated with sensing element 25. Accordingly, the inner diameter portion of disk is a useful location for a sensing element, particularly for side 24, which is otherwise a transmissive side of disk 20.

Sensing elements 15, 25 of optical disks 10, 20 may be realized via one or more screen printing dyes that change in response to exposure to an environmental condition. The degradation of the printing dyes in sensing elements 15, 25 can be made to be visually recognizable to a user. In this manner, sensing elements 15, 25 can alert the user to possible media degradation, and thereby promote the integrity of data stored on disks 10, 20.

UV radiation is a particular concern to optical disks, especially disks that make use of one or more dye-based optical recording layers. UV radiation can affect the quality of such dye based optical recording media, and may cause otherwise good recordings to go bad.

An Atlas Weatherometer at 1.1 W/mˆ2 (@420 nm) is designed to perform acceleration tests for sun exposure. Ninety hours of UV exposure in the Atlas Weatherometer emulates approximately one month of Florida sun behind a pane of window-glass. In such an exposure, many optical media samples degrade to an extent that error rates of such media climb above correctable specification limits. Many optical disk consumers may be inadvertently placing optical media at risk of degradation by leaving it in a car dash or on a sun-drenched table. A visual indicator such as sensing element 15 or 25 on disks 10 or 20 can provide the user with some warning to recopy valuable information before such information is lost and unrecoverable. By printing a warning label (sensing element) that comprises inks that fade at differing rates in UV light, the invention can realize a visible indicator that becomes increasingly prominent as UV exposure increases.

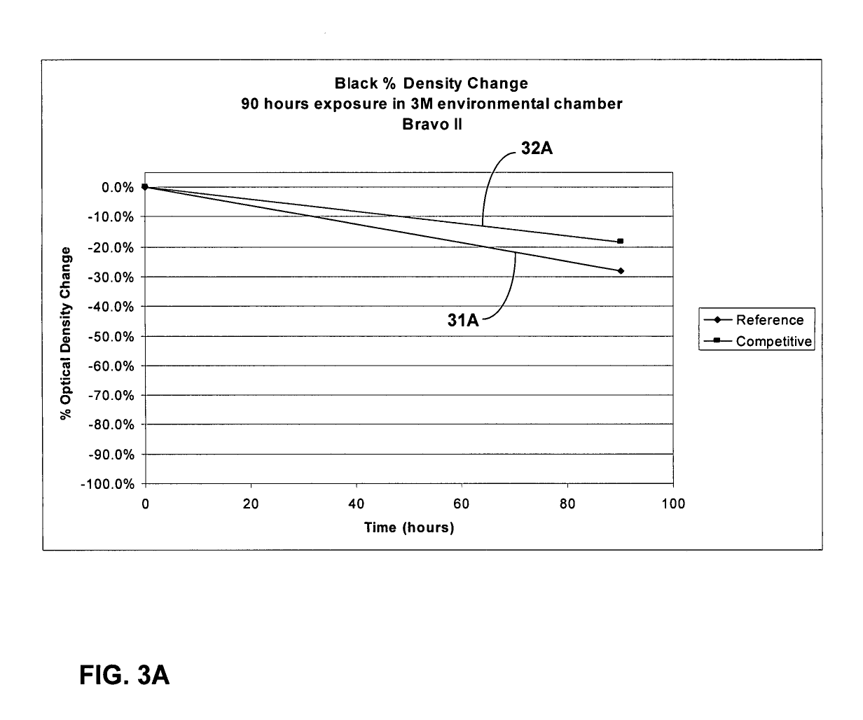

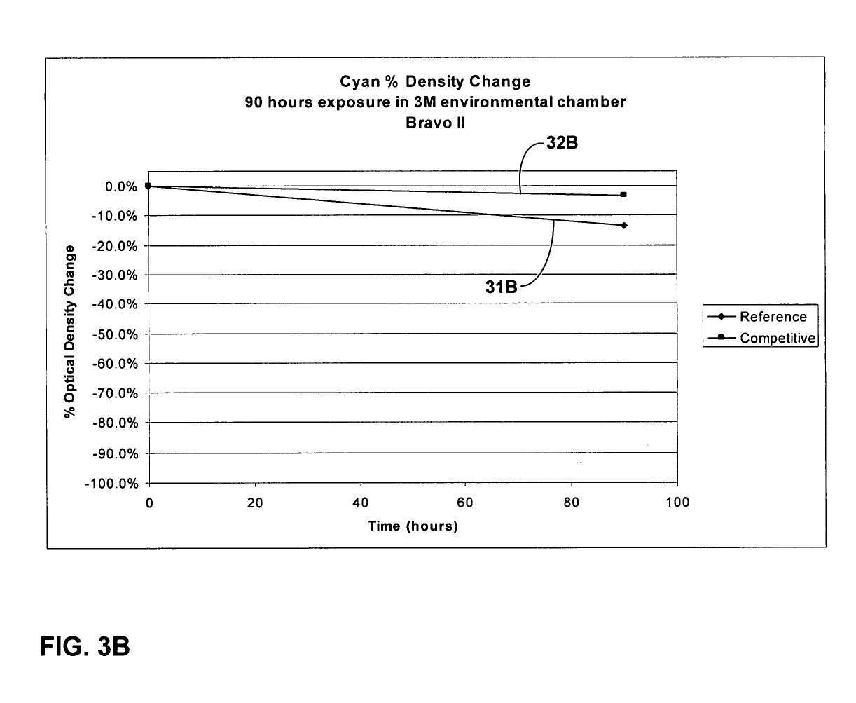

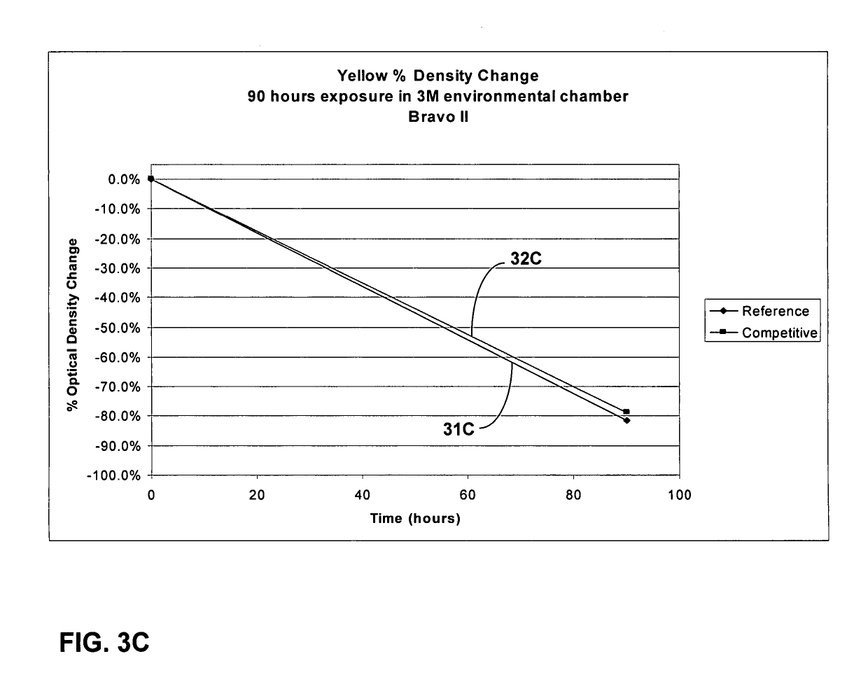

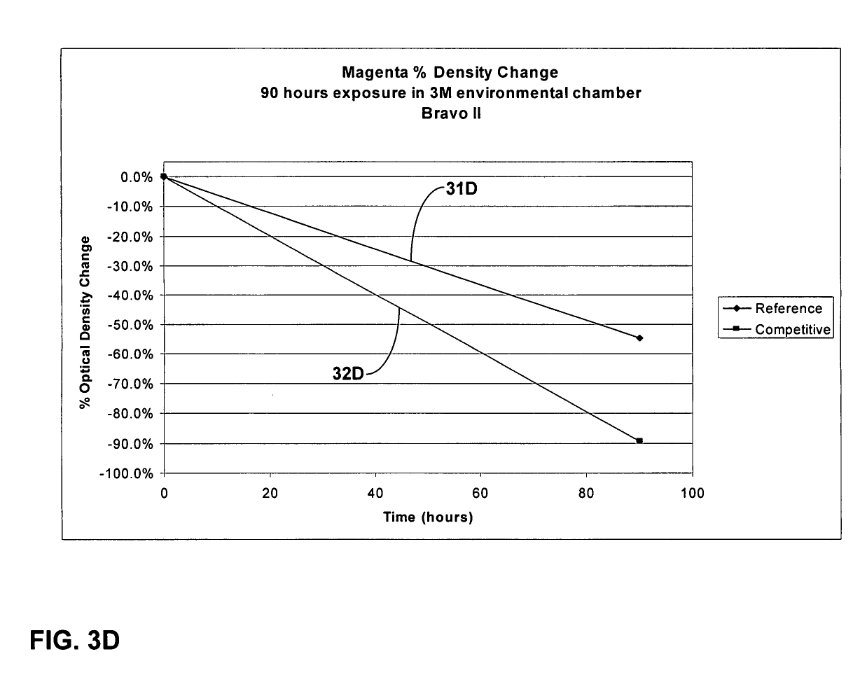

FIGS. 3A-3D are graphs illustrating different rates of decay for different colorants exposed to UV radiation. In particular, FIGS. 3A-3D illustrate experimental details of colorant changes for disks printed with a dye-based ink onto a inkjet receptor surface and then subjected to an accelerated UV light soaking chamber for 90 hours. For this example data, the disks were printed with a Primera Bravo II duplication system with a Lexmark dye-based ink. The densitometer data is shown in FIGS. 3A-3D in the form of percentage (%) change in optical density versus time in the chamber

As shown in FIGS. 3A-3D, the rates of decay for cyan, magenta, yellow and black inks can differ very drastically. The visual changes can depend on both the material composition and the microstructure/porosity of the inkjet receptive surface as well as the printing dye. Pigmented inks may also be used with, typically, much less environmentally stimulated change. In each of FIGS. 3A-3B, a plot of reference data 31A-31D is shown relative to a plot of competitive data 32A-32D. The reference data 31 monitors an experimental Imation inkjet surface, whereas the competitive data monitors a Taiyo-Yuden inkjet receptive surface.

As can be appreciated from FIGS. 3A-3D, it is possible to engineer a visual sensing element based on colorants decaying at different rates when subjected to UV exposure. As shown in the example data of FIG. 3A, after 90 hours of accelerated UV exposure, the black colorant decayed approximately 18-28 percent for the two types of inkjet receptive surfaces, whereas the cyan colorant decayed approximately 3-13 percent, the yellow colorant decayed approximately 78-82 percent, and the magenta colorant decayed approximately 55-90 percent. Of course, these results are particular for these two types of inkjet receptive surfaces and this particular dye-based ink. Different differential colorant decays would be expected for differing types of inks and different inkjet receptive surfaces.

Based on the data shown in FIGS. 3A-3D, it is apparent that different colorants can be used to create a visual sensor that changes its visual appearance upon exposure to UV radiation. For example, if a composite color warning label is printed onto a disk surface with a more UV light stable color (i.e., cyan and/or black) and then overprinted with a less UV light stable color (i.e., magenta and/or yellow), a visual UV sensitive sensing element can be realized. In this case, when the disk is exposed to UV radiation, the color warning message will become increasingly apparent.

Other inks, however, may decay different from the data points shown in FIGS. 3A-3D. Accordingly, the invention is not limited to the differential colorant decays shown in FIGS. 3A-3D, but generally contemplate a variety of visual sensor designs that make use of differential ink or colorant decay. In alternative cases (due to different inks), the yellow and/or magenta colorants may have less decay than cyan and/or black. Also, the invention contemplates the use of two or more colorants that have the same color, yet decay at different rates (e.g., due to different ink formulations). A wide variety of visual sensor designs could be created in view of these observations.

In some cases, color shifting could be used as an indicator itself. In this case, a composite color patch may shift from green (using cyan+yellow) to blue (cyan only) to indicate that the disk has been exposed to excessive UV radiation. The actual ink responses to levels of UV radiation (or other environmental conditions) and the desired visual results caused by ink decay may be strongly dependent upon the inks used for the sensing element. Given the observations of variable decay shown in FIGS. 3A-3D, however, a person with ordinary skill in the art could easily design a number of different sensing elements without any undue experimentation.

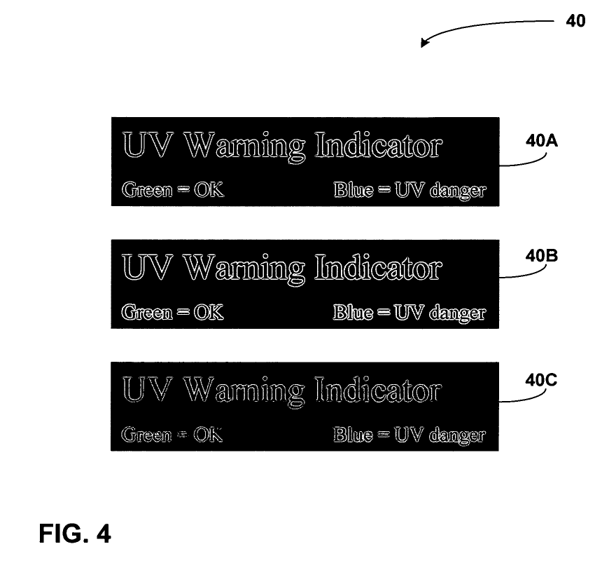

FIG. 4 illustrates one exemplary sensing element 40 that may be used to sense UV radiation. Sensing element 40 may correspond to either of elements 15 or 25 in FIGS. 1 and 2, respectively. Three examples (40A, 40B and 40C) of sensing element 40 are shown, which may correspond to the same element upon exposure to different levels of UV radiation. In this example, sensing element 40 includes an identification that it is “UV Warning Indicator.” Sensing element 40 further includes an explanation that if it appears “Green” then the data is OK, but if sensing element 40 appears blue, the data may be in danger of loss or corruption due to UV radiation exposure.

In example 40A, sensing element 40 may appear green, indicating that the disk has not been exposed to substantial radiation. In example 40C, however, sensing element 40 may appear blue, indicating that the disk has been exposed to substantial radiation. In intermediate example 40B, some decay may have occurred, making sensing element 40 appear between blue and green, i.e., turquoise. A user may interpret this color coded sensing element 40 to determine if and when data backup should be performed to ensure that data is not lost from the disk. In the examples of FIG. 4, the colorants may be mixed to define a composite dye or the colorants may be separate and overprinted over one another. In the later case, the more UV sensitive dyes may be printed over the less UV sensitive dyes. Furthermore, the text may be written using more extensive amounts of black and/or cyan than that used in other areas, in order to make the text distinguishable from the cyan color that is visible when the yellow colorant decays (as shown in 4C).

In yet another example, a message could be displayed to indicate that the medium is okay. In this case, as the message fades, the user can be alerted to possible media degradation. In this manner, a color sensor element that implements color fade alone could be used to provide a visual indication of media degradation as a result of environmental exposure.

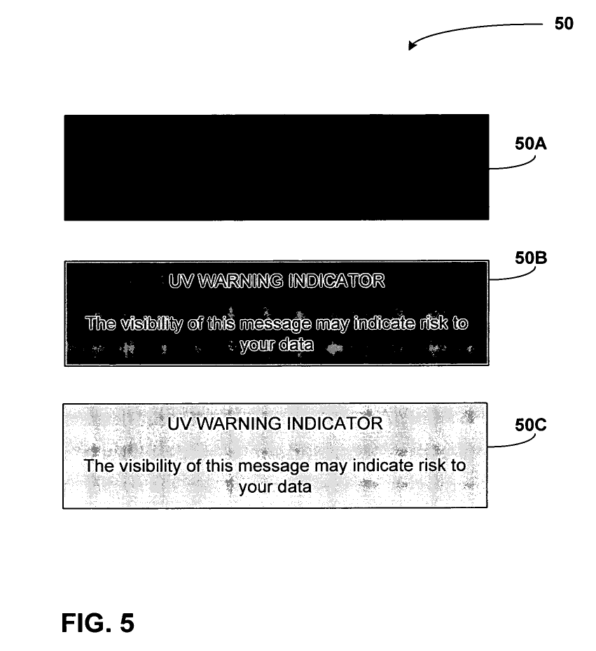

FIG. 5 illustrates another exemplary sensing element 50 that may be used to sense UV radiation. Sensing element 50 may correspond to either of elements 15 or 25 in FIGS. 1 and 2 respectively. Three examples (50A, 50B and 50C) of sensing element 50 are shown, which may correspond to the same element upon exposure to different levels of UV radiation. In this example, sensing element 50 includes a textual message that reads “UV Warning Indicator—The visibility of this message may indicate risk to your data.” This message may be written using a first colorant (cyan or black). The message may then be overprinted with a second colorant (magenta or yellow). By overprinting the message with the second colorant, the message is covered, as shown in 5A. However, upon exposure to UV radiation past a threshold, the message may appear, as shown in 5B, due to decay of the second colorant that is overprinted. As shown in 5C, the message becomes even more apparent following substantial UV exposure and thus substantial decay of the second colorant that is overprinted.

An inkjet printed color field may comprise a composite of individual colored dyes or pigments made of such colors as cyan, magenta and yellow and printed in pixel matrix fashion such that the resulting visual color matches the desired result before and after environmental exposure. The visual sensing element, however, need not be printed in the specific manner described herein, and could comprises other inks, dyes or components. As another example, the printing ink used for a sensing element could also comprise a mixture of two or more dye colors which selectively change to achieve the visual indication of the environmental exposure.

A number of embodiments of the invention have been described. In particular, the general concept of incorporating a visual sensing element on a data storage medium has been described to provide a visual indication of possible media degradation. Several specific embodiments were also described for UV sensitive sensing elements that may be printed on optical disks, which utilize differential decay qualities of different colorants. In accordance with the invention, various mixtures of colorants and sequential overprinting techniques may be easily designed to achieve a desired visual affect that is responsive to UV exposure. Threshold levels of UV exposure may be defined by the colorant levels or mixtures used for the sensing element.

Nevertheless, various modifications can be made to the specific teaching above, without departing from the scope of the following claims. For example, sensing elements may also be used to sense other environmental conditions or contaminants that may be destructive to a given type of optical disk or other type of data storage medium. Examples of other types of environmental conditions that might be detected by a sensing element, according to the invention, may include ozone, moisture, non-UV radiation in some non-UV spectrum of light, or one or more corrosive gases, such as smog, that may be present in the atmosphere. These or other types of environmental conditions may be detected by a sensing element according to the invention. Also, other types of inks (having differential decay rates different than that shown in FIGS. 3A-3D) may also be used. Even two colorants of the same color (with different ink formulations) could be used.

Furthermore, although the invention has been primarily described in the context of optical disks, the same concepts could be applied to other types of data storage media, such as holographic media, portable flash drives, data tape cartridges, or other media. In such cases, the detected environmental condition may correspond to a condition that can degrade or affect media quality. These and other embodiments are within the scope of the following claims.

1. A data storage medium comprising a visually recognizable sensing element that changes in appearance in response to exposure to an environmental condition.

2. The data storage medium of claim 1, wherein the data storage medium comprises an optical disk that includes:
a substrate that defines optically detectable features; and
one or more layers formed on the substrate, wherein the sensing element is formed on a surface of the optical disk.

3. The data storage medium of claim 2, wherein the one or more layers formed on the substrate include a recording dye.

4. The data storage medium of claim 2, wherein the one or more layers formed on the substrate include a reflector.

5. The data storage medium of claim 2, wherein the sensing element is formed on an inner diameter portion of the substrate.

6. The data storage medium of claim 5, wherein the medium includes a first side that is substantially optically transparent and a second side that is substantially optically opaque, and wherein the sensing element is formed on the inner diameter portion of the first side.

7. The data storage medium of claim 2, wherein the substrate includes a first side that is substantially optically transparent and a second side that is substantially optically opaque, and wherein the sensing element is formed on the second side.

8. The data storage medium of claim 1, wherein the environmental condition comprises ultraviolet light, and wherein the sensing element changes in appearance in response to exposure to the ultraviolet light.

9. The data storage medium of claim 8, wherein the sensing element comprises a plurality of colorants that decay at different rates upon exposure to the ultraviolet light.

10. The data storage medium of claim 9, wherein the colorants include a first colorant selected from cyan and black overprinted with a second colorant selected from magenta and yellow.

11. The data storage medium of claim 10, wherein the second colorant upon exposure to the ultraviolet light changes in density at a faster rate than the first colorant.

12. The data storage medium of claim 11, wherein the first colorant comprises a message overprinted by the second colorant, wherein the message becomes visible upon exposure to the ultraviolet light.

13. The data storage medium of claim 8, wherein a message appears on the sensing element following exposure to the ultraviolet light beyond a threshold.

14. The data storage medium of claim 13, wherein the message warns of possible ultraviolet exposure to the medium.

15. The data storage medium of claim 13, wherein the message warns of a risk of data loss from the medium.

16. The data storage medium of claim 8, wherein a color of the sensing element changes following exposure to ultraviolet light beyond a threshold due to differential decay of different colorants in the sensing element.

17. The data storage medium of claim 1, wherein the environmental condition comprises ozone, and wherein the sensing element changes in appearance in response to exposure to the ozone.

18. The data storage medium of claim 1, wherein the environmental condition comprises moisture, and wherein the sensing element changes in appearance in response to exposure to the moisture.

19. The data storage medium of claim 1, wherein the environmental condition comprises a non-UV spectrum of light, and wherein the sensing element changes in appearance in response to exposure to the non-UV spectrum of light.

20. The data storage medium of claim 1, wherein the environmental condition comprises a corrosive gas, wherein the sensing element changes in appearance in response to exposure to the corrosive gas.
